(19) United States
(12) Patent Application Publication
(10) Pub. No.: US 2025/0106591 A1
(43) Pub. Date: Mar. 27, 2025

(54) USER STATE DETERMINATION DEVICE

(71) Applicant: NTT DOCOMO, INC., Tokyo (JP)

(72) Inventors: Shu ISHIKAWA, Chiyoda-ku (JP); Shin ISHIGURO, Chiyoda-ku (JP); Tomohiro MIMURA, Chiyoda-ku (JP); Ryou KOYAMA, Chiyoda-ku (JP); Akira YAMADA, Chiyoda-ku (JP); Takashi SUZUKI, Chiyoda-ku (JP)

(73) Assignee: NTT DOCOMO, INC., Tokyo (JP)

(21) Appl. No.: 18/832,678

(22) PCT Filed: Feb. 24, 2023
(86) PCT No.: PCT/JP2023/006859

§ 371 Date: Jul. 24, 2024

(30) Foreign Application Priority Data
Apr. 7, 2022 (JP) 2022-064041

(51) Int. Cl. H04W 4/02; H04W 4/021; H04W 4/029; H04W 64/00

(52) U.S. Cl. CPC H04W 4/025; H04W 4/021; H04W 4/029; H04W 64/006

(57) ABSTRACT

A user state determination device that can simply determine a location at which a user has fallen into a user state in which the user has lost an article or the like is provided. The user state determination device 100 includes: a user information acquiring unit 101 configured to acquire moving history information of a user; and a state determining unit 102 configured to determine that one spot (one location) serving as a start point of a predetermined moving pattern is likely to be a specific spot (a specific location) at which the user has fallen into a predetermined state (a state in which the user has lost an article) when the moving history information indicates the moving pattern. The predetermined state of a user refers to a state in which an article has been lost and is a state in which the user needs to perform a non-purposeful visit to the one spot (a visit to retrieve the lost article).

### TECHNICAL FIELD

The present disclosure relates to a user determination device that determines a user state in which a user has lost an article or the like.

### BACKGROUND ART

In Patent Literature 1, a system that notifies a user that there is a lost article when loss of the article has been detected is described.

### CITATION LIST

### Patent Literature

Japanese Unexamined Patent Publication No. 2022-27121

### SUMMARY OF INVENTION

### Technical Problem

In the technique described in Patent Literature 1, when an object detecting unit detects a lost article, a user can be notified that loss of the article has occurred. Accordingly, a special sensor such as the object detecting unit needs to be provided at a location at which an article is likely to be lost in advance, but it may be difficult to determine a location at which an article is likely to be lost.

Therefore, in order to solve the aforementioned problem, an objective of the present disclosure is to provide a user state determination device that can simply determine a location at which a user has fallen into a user state in which the user has lost an article or the like.

### Solution to Problem

A user state determination device according to the present disclosure includes: an acquisition unit configured to acquire moving history information of a user; and a determination unit configured to determine that one location serving as a start point of a predetermined moving pattern is likely to be a specific location at which the user has fallen into a predetermined state when the moving history information indicates the moving pattern.

### Advantageous Effects of Invention

According to the present disclosure, it is possible to simply determine a location at which a user has fallen into a user state in which the user has lost an article or the like.

### BRIEF DESCRIPTION OF DRAWINGS

FIG. 1 is a diagram illustrating a moving pattern when a user has lost an article as an example of a user state according to the present disclosure.

FIG. 2 is a diagram illustrating a system configuration of a system including a user state determination device 100.

FIG. 3 is a block diagram illustrating a functional configuration of the user state determination device 100 according to the present disclosure.

FIG. 4 is a diagram illustrating a specific example of a spot DB 103.

FIG. 5 is a diagram illustrating a specific example of a loss history DB 104.

FIG. 6 is a flowchart illustrating operations of the user state determination device 100.

FIG. 7 is a block diagram illustrating a functional configuration of a lost article notification device 300.

FIG. 8 is a conceptual diagram illustrating an estimation process according to the present disclosure.

FIG. 9 is a flowchart illustrating operations of the lost article notification device 300.

FIG. 10 is a diagram illustrating an example of a hardware configuration of the user state determination device 100 and the lost article notification device 300 according to an embodiment of the present disclosure.

### DESCRIPTION OF EMBODIMENTS

An embodiment of the present disclosure will be described below with reference to the accompanying drawings. As much as possible, the same elements will be referred to by the same reference signs, and repeated description thereof will be omitted.

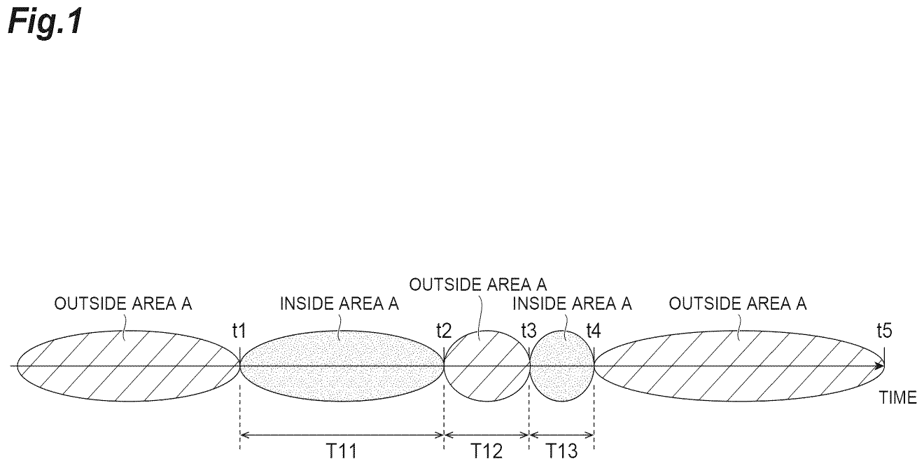

FIG. 1 is a diagram illustrating a moving pattern when a user has lost an article as an example of a user state according to the present disclosure. In the drawing, it is assumed that a user is located outside of an area A at the first time. Thereafter, the user enters the area A at time t1. Then, the user stays in a spot included in the area A for a predetermined minimum stay time T11 or longer and then leaves the area A (a specific spot). Within a first time T12, the user returns to the area A and leaves the area A after a second time T13 elapses. Here, the first time T12 indicates a time required for the user to find that an article has been lost and to return to the area. The first time T12 is a predetermined time. The time T12 is a time acquired through investigation of statistical data of lost articles in advance. The second time T13 is a time for retrieval of an article when the article has been lost. A maximum lost article retrieval time for retrieving a lost article is set, and the second time T13 needs to be less than the maximum lost article retrieval time.

In this way, when a user adopts a moving pattern in which the user leaves the area A including a spot, returns to the area A, and leaves the area A again after a shorter time, it is determined that a lost article detection condition has been satisfied. That is, it is determined that the user has lost an article and the spot is a specific spot. This spot is, for example, a coffee shop, a restaurant, a train, or a station.

In the present disclosure, a moving history of each user is stored in the units of areas, and when there is a spot such as a store included in an area satisfying the lost article detection condition, the spot is determined to be a specific spot. The lost article detection condition in the present disclosure is set to a condition that a user leaves a specific spot, then returns to the specific spot, and leaves the specific spot again after a short time as described above, but the present disclosure is not limited thereto.

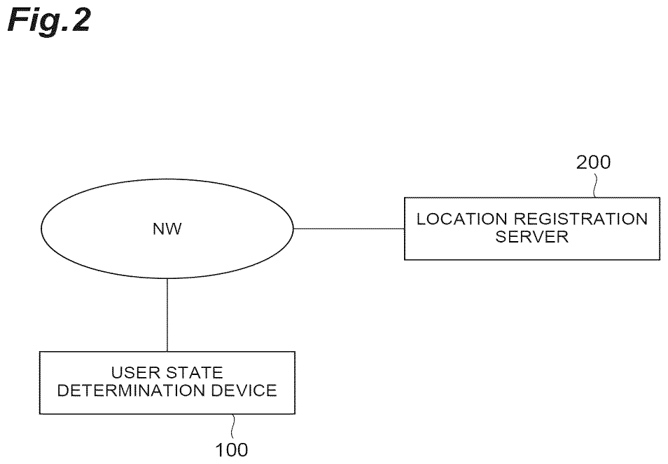

A configuration of a system including a user state determination device 100 that determines a moving history in which a user has fallen into a specific user state will be described below. FIG. 2 is a diagram illustrating a system configuration of a system including a user state determination device 100. As illustrated in the drawing, the system includes a user state determination device 100 and a location registration server 200. The location registration server 200 is, for example, a server that stores a user ID of a mobile terminal owned by a user and position information thereof in correlation. The position information may be acquired using position information of a base station constituting a mobile communication network used by the mobile terminal, or position information acquired by a positioning function (such as GPS) of the mobile terminal may be stored.

The user state determination device 100 according to the present disclosure can determine that a user has lost an article and a lost-article spot at which an article is likely to have been lost by detecting a moving history specific to a user state of the user illustrated in FIG. 1 using position information of a plurality of users stored in the location registration server 200.

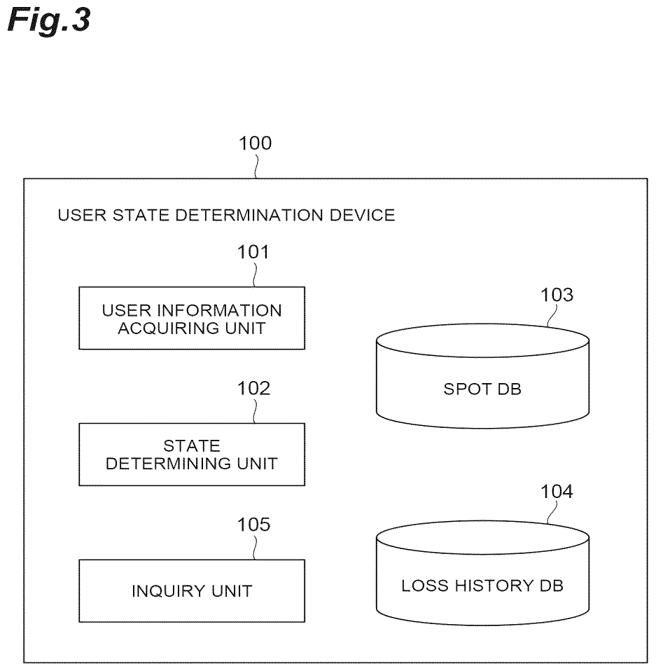

FIG. 3 is a block diagram illustrating a functional configuration of the user state determination device 100 according to the present disclosure. As illustrated in the drawing, the user state determination device 100 includes a user information acquiring unit 101, a state determining unit 102, a spot DB 103, a loss history DB 104, and an inquiry unit 105.

The user information acquiring unit 101 is a part that acquires moving history information based on position information of a user from the location registration server 200. The position information includes time information at that time.

The state determining unit 102 is a part that determines whether a user has fallen into a predetermined user state on the basis of the acquired moving history information and management information stored in the spot DB 103. In the present disclosure, the predetermined user state is assumed to be a state in which a user has lost an article (or dropped the article). When the moving history information indicates a moving history specific to a case in which a user has lost an article with an area including a predetermined spot (a lost article detection target spot) as a start point, the state determining unit 102 determines that the spot included in the area serving as the start point is a specific spot. Then, the state determining unit 102 generates loss history information on the basis of the specific spot in the loss history DB 104 and stores the generated loss history information in the loss history DB 104. Thereafter, when a result indicating that an article has been lost is acquired as a result of inquiry in the inquiry unit 105, the loss history DB 104 updates the loss history information.

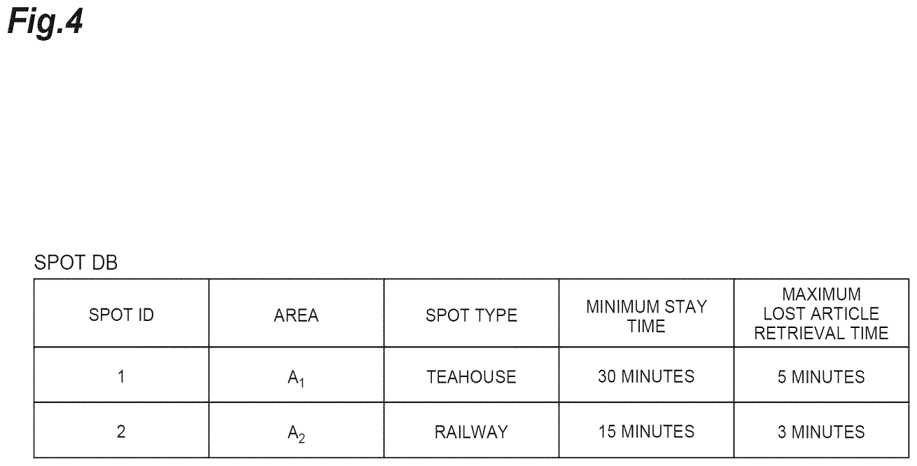

The spot DB 103 is a database that stores management information of a lost article detection target spot. FIG. 4 is a diagram illustrating a specific example of the spot DB 103. As illustrated in the drawing, the spot DB 103 stores a spot ID, an area, a spot type, a minimum stay time, and a maximum lost article retrieval time. In the present disclosure, a predetermined spot at which an article is likely to be lost is defined as a lost article detection target spot along with following information.

The spot ID is an identifier for identifying a spot. The spot is a location at which loss of an article occurs such as a store or a railway.

The area is an area corresponding to the spot and includes one or more spots. The area is formed in an arbitrary size or shape.

The spot type represents a business type of the spot. The business type represents a teahouse, a railway, or the like.

The minimum stay time represents a stay time minimally required for a user to use the spot. The minimum stay time is, for example, a time which is determined on the basis of the prediction that a user will stay about 30 minutes in a teahouse. The time T11 in FIG. 1 indicates the minimum stay time or longer.

The maximum lost article retrieval time is a time required for a user to retrieve a lost article when the user goes to the spot. This time is set to, for example, a short time such as 5 minutes for a teahouse. The time T13 in FIG. 1 is less than the maximum lost article retrieval time.

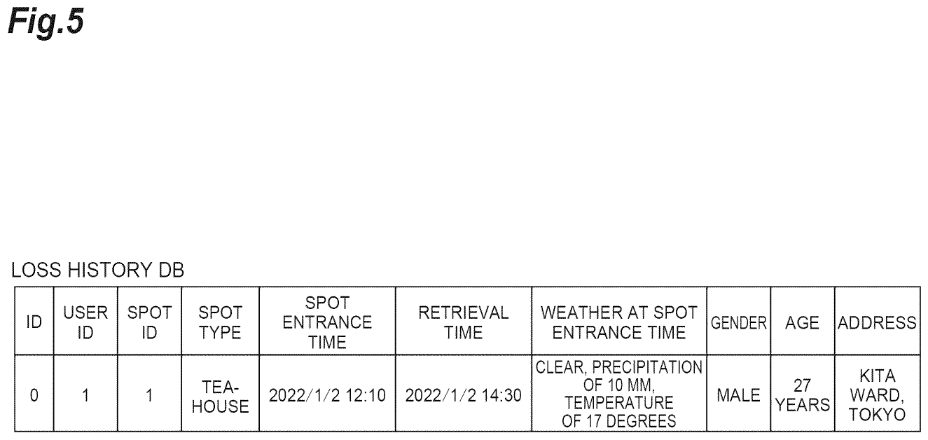

The loss history DB 104 is a database that stores information on a specific spot at which an article has been lost by each user. The loss history DB 104 stores spot information of the user ID or the like according to a result of determination from the state determining unit 102 and a result of inquiry from the inquiry unit 105. FIG. 5 is a diagram illustrating a specific example of the loss history DB 104. As illustrated in the drawing, the loss history DB 104 stores an ID, a user ID, a spot ID, a spot type, spot entrance time, retrieval time, the weather at the spot entrance time, and user information (gender, age, and address of a user).

The ID is a loss history ID and is an identifier allocated to each record of a lost article. The user ID is an identifier of a user who has lost an article. The spot ID is an identifier of a specific spot (such as a store) at which an article has been determined to be lost. The spot type indicates a business type of the spot and is, for example, a type of a store such as a teahouse. The spot entrance time is time at which the user has entered the spot. The retrieval time is time at which the user has retrieved an article when the article has been lost. The weather at the spot entrance time includes an amount of precipitation and the temperature.

The spot ID and the spot type are read from the spot DB 103 and registered in the loss history DB 104 by the state determining unit 102. The spot entrance time and the retrieval time are determined on the basis of the moving history based on the position information. For example, the spot entrance time and the retrieval time are determined on the basis of time at which the user has entered the spot (for example, a time required for the retrieval operation is added thereto). The weather is read from a weather database (not illustrated) on the basis of the position of the spot and the retrieval time by the state determining unit 102 and is registered in the loss history DB 104. The user information is read from a user management database (not illustrated) by the state determining unit 102 and is registered in the loss history DB 104. The user management database can use, for example, a mobile phone contractor DB.

The inquiry unit 105 is a part that inquires of a user, a specific spot (such as a store), or another third-party agency about whether the user has lost an article (or whether the user is likely to have lost an article) according to determination of the state determining unit 102 and acquires a result of inquiry. The inquiry unit 105 updates lost history information in the loss history DB 104 on the basis of the result of inquiry.

The following method is conceivable as the method of inquiry. For example, the inquiry unit 105 inquires of a user about whether the user has lost an article at a specific spot at time based on entrance time thereinto. The inquiry unit 105 acquires a result of inquiry indicating whether the user has lost an article by allowing the user to respond to the inquiry through inputting or the like. The inquiry may use an electronic mail, a message application, an SNS, or the like.

As another method, the inquiry unit 105 may inquire of a specific spot at which a user is determined to have lost an article and acquire a result of inquiry indicating whether loss of an article has occurred after the entrance time thereinto and the lost article has been retrieved.

The inquiry unit 105 refers to (inquires about) a settlement history of a user of which a lost article has been detected and acquires a result of inquiry indicating that an article has been lost from the settlement history when settlement is not recorded at a predetermined time width from time at which the user went to the specific spot to retrieve the lost article. The settlement history is stored in a settlement history server (not illustrated) of a credit company or the like.

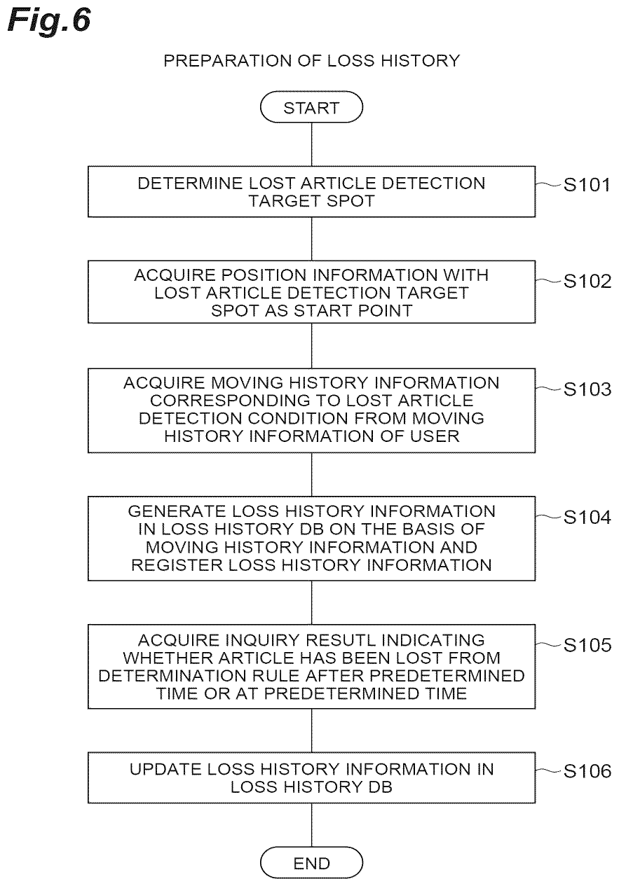

FIG. 6 is a flowchart illustrating operations of the user state determination device 100. The user information acquiring unit 101 determines a lost article detection target spot (S101). The user information acquiring unit 101 determines the lost article detection target spot with reference to the spot DB 103. The user information acquiring unit 101 acquires position information of a user matching the lost article detection target spot or in a predetermined range therefrom (adjacent thereto) and acquires moving history information with the position information as a start point (S102).

Then, the state determining unit 102 acquires moving history information corresponding to a lost article detection condition from the moving history information of the user and determines a spot in an area serving as the start point to be a specific spot (S103).

Then, the state determining unit 102 generates loss history information on the basis of the moving history information and registers the generated loss history information in the loss history DB 104 (S104). That is, when the specific spot is determined, the state determining unit 102 reads a spot ID and a spot type from the spot DB 103. An area is acquired from the position information, and a spot ID and a spot type corresponding to the area are identified.

The state determining unit 102 acquires spot entrance time and retrieval time from the position information of a user (a user ID) acquired by the user information acquiring unit 101. The state determining unit 102 acquires attribute information (gender, age, and address) of the user (the user ID) from the user information server. Then, the state determining unit 102 stores the information as loss history information in the loss history DB 104 (S105).

The inquiry unit 105 acquires a result of inquiry by preforming an inquiry process of inquiring about whether an article has been lost according to a determination rule after a predetermined time elapses or at predetermined time (S105).

The inquiry unit 105 updates the loss history information in the loss history DB 104 (S106). That is, when the result of inquiry indicates that an article has not been lost, the inquiry unit 105 deletes loss history information indicating that an article has not been actually lost out of the loss history information stored in the loss history DB 104. When the result of inquiry indicates that an article has been lost, the inquiry unit 105 does not perform an updating process.

Through this process, information including by whom, where, and when an article has been lost can be automatically constructed as a loss history.

In S102, the lost article detection target spot is determined and moving history information with the spot as a start point is determined as one condition for determining a specific spot, but the lost article detection target spot is not necessary. A spot serving as a start point of the moving history information based on the lost article detection condition may be determined as the specific spot. That is, the spot DB 103 includes management information of all spots, and the user state determination device 100 may determine a start point of the moving history information based on the lost article detection condition out of the whole moving history information as a specific spot.

A lost article estimating process using loss history information in the loss history DB 104 will be described below.

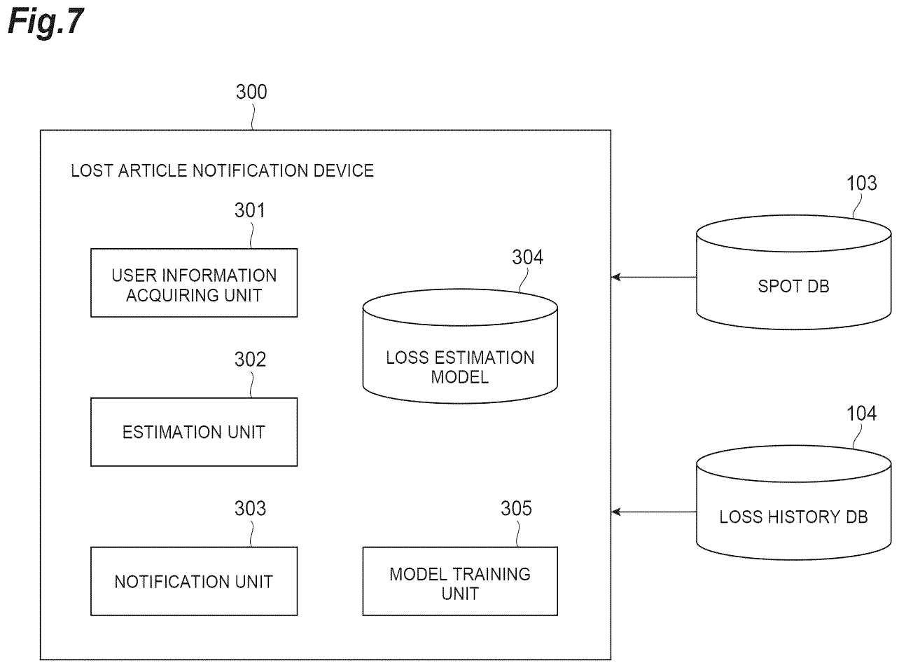

FIG. 7 is a block diagram illustrating a functional configuration of a lost article notification device 300. As illustrated in the drawing, the lost article notification device 300 includes a user information acquiring unit 301, an estimation unit 302, a notification unit 303, a loss estimation model 304, and a model training unit 305.

The user information acquiring unit 301 is a part that acquires position information of a user and determines whether the user has stayed in a lost article detection target spot for a predetermined time on the basis of the position information. As described above, the position information is acquired from the location registration server 200.

The user information acquiring unit 301 acquires a spot, the weather at that position, and a current time at that position on the basis of the position information of the user. The user information acquiring unit 301 acquires loss frequency information in a predetermined period from the loss history information.

The estimation unit 302 is a part that acquires a loss probability of the user using the current position information of the user, the current time, and the loss estimation model 304. That is, the estimation unit 302 acquires a spot and the weather from the current position information of the user and the current time, inputs feature information thereof to the loss estimation model 304, and acquires an estimated loss probability which is a result thereof.

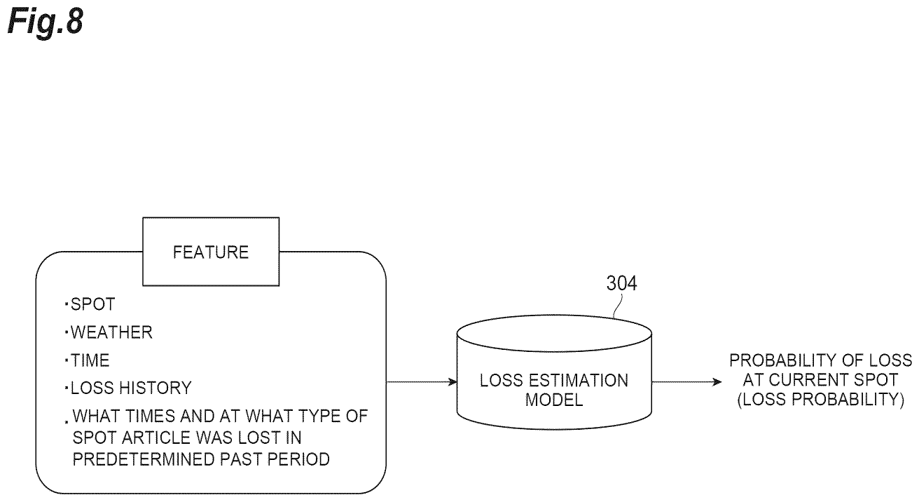

FIG. 8 is a conceptual diagram illustrating an estimation process according to the present disclosure. As illustrated in the drawing, a spot, the weather, time, a loss history which are features are input to the loss estimation model 304, and a loss probability with which an article will be lost at the current spot is output therefrom. The loss history as a feature is a feature indicating in what type of spot and what times an article has been lost in a predetermined period in the past. For example, a user has lost an article three times in a teahouse which is a spot type.

The notification unit 303 is a part that notifies a user of a loss probability.

The model training unit 305 is a part that trains and constructs the loss estimation model 304. The model training unit 305 does not have to be provided in the lost article notification device 300 and may be provided in a separate learning device.

The model training unit 305 trains the loss estimation model 304 by performing machine learning with spot, weather, time, and loss history (loss frequency) as explanatory variables and with a probability with which an article will be lost in the spot as an objective variable. The loss history which is an explanatory variable is a feature indicating in what type of spot and what times an article has been lost in a predetermined period in the past. For example, a user has lost an article three times in a teahouse which is a spot type. The loss probability of an article is a numerical value indicating whether a visit to the spot is a non-purposeful visit (including an unplanned visit) in a wide sense.

The model training unit 305 may perform learning using the loss history information for one user or may perform learning using the loss history information of all users.

More specific explanatory variables include numerical values to which behavior and attributes of a user are vectorized. The explanatory variables are not limited to one-hot vectors.

Examples of explanatory variables
one-hot vector of a spot ID of a spot
one-hot vector of a spot type of a spot
one-hot vector of the weather at the time of a first visit to a spot
precipitation at the time of a first visit to a spot
temperature at the time of a first visit to a spot
one-hot vector of a day at the time of a first visit to a spot
time at the time of a first visit to a spot (0 to 1440: minutes/days)
date at the time of a first visit to a spot (0 to 365: days/year)
whether a user is male (0/1)
age of a user
one-hot vector of an address of a user
number of times a user has lost an article at a spot in one month in the past

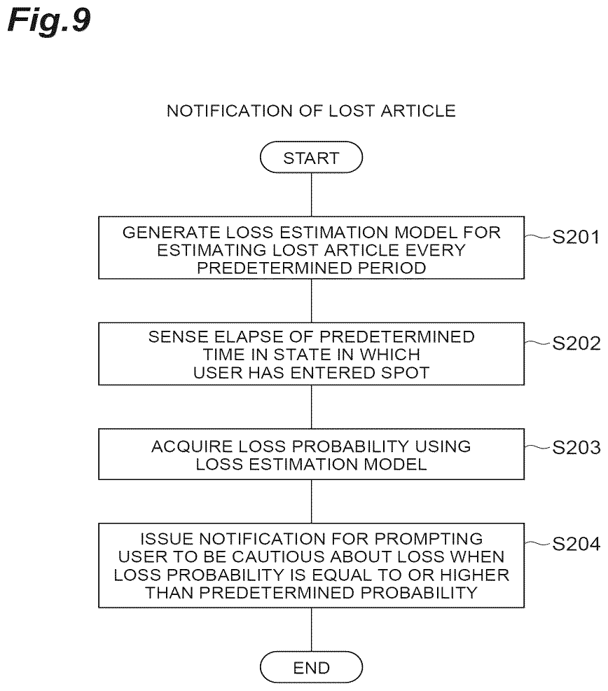

Operations of the lost article notification device 300 according to the present disclosure will be described below. FIG. 9 is a flowchart illustrating the operations of the lost article notification device 300. As illustrated in the drawing, the model training unit 305 generates a loss estimation model 304 for estimating a lost article every predetermined period (S201). This process is not necessary, and loss estimation models 304 generated at different locations may be used.

The user information acquiring unit 301 acquires position information of a user and determines whether a predetermined time has elapsed in a state in which the user entered one spot (which includes a spot other than a lost article detection target spot) on the basis of the position information (S202). The predetermined time is preferably set to the minimum stay time, but is not limited thereto. The user information acquiring unit 301 acquires a spot, the weather at that position, and current time at that position on the basis of the position information of the user.

When it is determined that the user has stayed in one spot for a predetermined time, the estimation unit 302 inputs the features acquired by the user information acquiring unit 301 to the loss estimation model 304 and acquires a loss probability (S203).

When the acquired loss probability is equal to or greater than a predetermined probability, the notification unit 303 issues a notification for prompting a user to be cautious about a loss (S204).

Detection in a case in which an article has been lost and which is an example of a user state in the user state determination device 100 will be described below.

When a teahouse is a spot registered in the spot DB 103, the state determining unit 102 determines that a user has left the teahouse after staying in the teahouse for 30 minutes or more, has visited the teahouse again within 24 hours, and has left the teahouse within 10 minutes on the basis of a moving history. In this case, the state determining unit 102 determines that the user is in a predetermined user state. That is, the state determining unit 102 determines that the user has lost an article in the teahouse. Then, the teahouse is determined to be a specific spot.

In another example, when it is determined that a user has left a route area after staying in the route area for 15 minutes or more, has visited an alighting station again within 12 hours, and has left the route area within 5 minutes, the state determining unit 102 determines that the user is in a predetermined user state. The route area is determined to be a specific spot.

In another example, when a user has left home after staying at the home for 5 hours or more, has visited the home again within 20 minutes, and has left the home within 5 minutes, the home is determined to be a specific spot.

Operations and advantages of the user state determination device 100 according to the present disclosure will be described below.

The user state determination device 100 according to the present disclosure includes the user information acquiring unit 101 configured to acquire moving history information of a user and the state determining unit 102 configured to determine that one spot (one location) serving as a start point of a predetermined moving pattern is likely to be a specific spot (a specific location) at which the user has fallen into a predetermined state (a state in which the user has lost an article) when the moving history information indicates the moving pattern. In the present disclosure, the predetermined state of a user is a state in which an article has been lost and is a state in which the user needs to perform a non-purposeful visit to the one spot (a visit to retrieve the lost article).

The state determining unit 102 determines that the one spot (one location) is the specific spot (a specific location) at which the user has fallen into the predetermined state when the user has left the one spot (one location) such as a teahouse, then has returned to the one spot (one location), and has left the one spot after a short time on the basis of the moving history.

The state determining unit 102 determines that the user is in the predetermined state when a time taken for the user to leave the one spot (one location) and to return to the one spot is less than a predetermined time. In the present disclosure, for example, when the user returns to a teahouse within 12 hours after the user has left the teahouse, it is determined that the user has lost an article (or is likely to have lost an article).

Since the moving history information includes position information and time information, the state determining unit 102 can determine when the user has been where.

The state determining unit 102 determines that the user is in the predetermined state additionally on the basis of an external factor (for example, the weather) at the one spot (one location). For example, when it is raining while the user is staying in the teahouse (raining stops at the time of leaving the teahouse), it can be determined that an umbrella is likely to have been lost.

The state determining unit 102 determines that the user is in the predetermined state additionally on the basis of attributes of the one spot (one location). For example, the attributes are a type indicating the location at which the user stays in a predetermined time such as a teahouse. In the present disclosure, the attributes of a spot indicate types such as a station, a railroad, and a location at which a user stays in a predetermined time in addition to a teahouse.

The user state determination device 100 further includes the inquiry unit 105 configured to inquire of a predetermined destination about whether the user is in the predetermined state when the state determining unit 102 determines whether the user is in the predetermined state (a state in which an article has been lost or the like). The inquiry unit 105 determines whether the user is in the predetermined state on the basis of a response to the inquiry when the response is received. In the present disclosure, the inquiry unit 105 updates the loss history information on the basis of the response.

The lost article notification device 300 which is a user state estimation device includes the estimation unit 302 configured to estimate that one user is in the predetermined state from the one user's information (behavior information and attribute information) using a trained loss estimation model 304 (a predetermined state estimation model) trained with the specific location acquired by the user state determination device 100 and information (for example, behavior information and attribute information) of one or more users as an explanatory variable and with a predetermined state (information indicating whether a user has lost an article) of each user as an objective variable.

The information of a user is, for example, behavior information and attribute information. The behavior information includes information indicating at what time the user has entered the specific spot and the weather at that time, and the attribute information includes the age of the user. At the time of learning, behavior information and attribute information of all the users are preferably used.

The user state determination device 100 according to the present disclosure employs the following configurations.
[1] A user state determination device including:
   an acquisition unit configured to acquire moving history information of a user; and
   a determination unit configured to determine that one location serving as a start point of a predetermined moving pattern is likely to be a specific location at which the user has fallen into a predetermined state when the moving history information indicates the moving pattern.
[2] The user state determination device according to [1], wherein the determination unit determines that the one location is the specific location at which the user has fallen into the predetermined state when the user has left the one location, then has returned to the one location, and then has left the one location within a predetermined time on the basis of the moving history.
[3] The user state determination device according to [2], wherein the determination unit determines that the user is in the predetermined state when a time taken for the user to leave the one location and to return to the one location is less than a predetermined time.
[4] The user state determination device according to [2] or [3], wherein the determination unit determines that the user is in the predetermined state additionally on the basis of an external factor at the one location.
[5] The user state determination device according to any one of [2] to [4], wherein the determination unit determines that the user is in the predetermined state additionally on the basis of attributes of the one location.
[6] The user state determination device according to any one of [1] to [5], wherein the predetermined state is a state in which the user needs to perform a non-purposeful visit to the one location.
[7] The user state determination device according to [6], wherein the non-purposeful visit to the one location is a visit based on the user's loss or dropping of an article.
[8] The user state determination device according to any one of [2] to [7], further including an inquiry unit configured to inquire of a predetermined destination about whether the user is in the predetermined state when the determination unit determines whether the user is in the predetermined state,
   wherein the inquiry unit determines whether the user is in the predetermined state on the basis of a response to the inquiry when the response is received.
[9] The user state determination device according to any one of [1] to [8], wherein the moving history information includes position information and time information.
[10 ] A user state estimation device including:
   an estimation unit configured to estimate that one user is in a predetermined state from the one user's behavior information at a specific location acquired by the user state determination device according to any one of [1] to [9] using a predetermined state estimation model trained with information of the specific location and one or more users as an explanatory variable and with a predetermined state of each of the one or more users as an objective variable.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

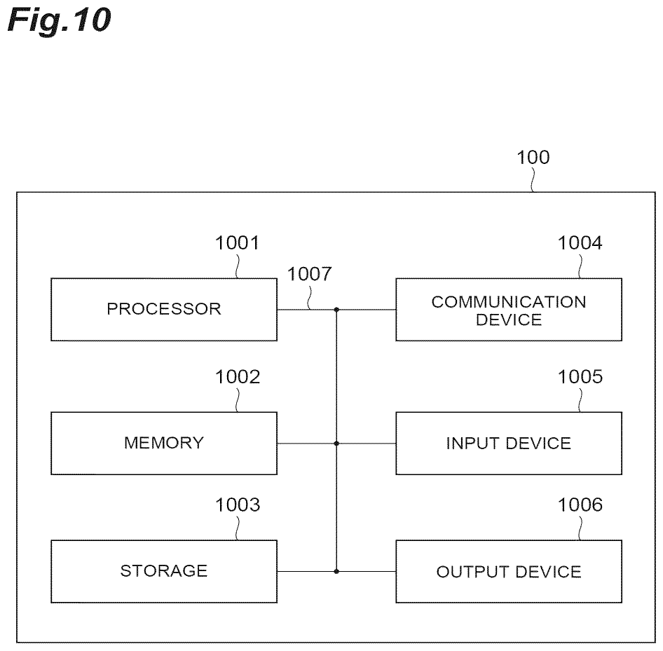

For example, the user state determination device 100 and the lost article notification device according to one embodiment of the present disclosure may function as a computer that performs processing of a user state determination method and a lost article notification method according to the present disclosure. FIG. 10 is a view showing an example of the hardware configuration of the user state determination device 100 and the lost article notification device 300 according to one embodiment of the present disclosure. The user state determination device 100 and the lost article notification device 300 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the user state determination device 100 and the lost article notification device 300 may be configured to include one or a plurality of the devices shown in the drawings or may be configured without including some of those devices.

The functions of the user state determination device 100 and the lost article notification device 300 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the state determining unit 102 described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the state determining unit 102 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing the user state determination method and the lost article notification method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described user information acquiring unit 101 and the inquiry unit 105 may be implemented by the communication device 1004. The user information acquiring unit 101 and the inquiry unit 105 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the user state determination device 100 and the lost article notification device 300 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middle ware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 . . . User state determination device, 200 . . . Location registration server, 101 . . . User information acquiring unit, 102 . . . State determining unit, 104 . . . Loss history DB, 103 . . . Spot DB, 105 . . . Inquiry unit, 300 . . . Lost article notification device, 301 . . . User information acquiring unit, 302 . . . Estimation unit, 303 . . . Notification unit, 304 . . . Loss estimation model, 305 . . . Model training unit

1. A user state determination device comprising:
an acquisition unit configured to acquire moving history information of a user; and
a determination unit configured to determine that one location serving as a start point of a predetermined moving pattern is likely to be a specific location at which the user has fallen into a predetermined state when the moving history information indicates the moving pattern.

2. The user state determination device according to claim 1, wherein the determination unit determines that the one location is the specific location at which the user has fallen into the predetermined state when the user has left the one location, then has returned to the one location, and then has left the one location within a predetermined time on the basis of the moving history.

3. The user state determination device according to claim 2, wherein the determination unit determines that the user is in the predetermined state when a time taken for the user to leave the one location and to return to the one location is less than a predetermined time.

4. The user state determination device according to claim 2, wherein the determination unit determines that the user is in the predetermined state additionally on the basis of an external factor at the one location.

5. The user state determination device according to claim 2, wherein the determination unit determines that the user is in the predetermined state additionally on the basis of attributes of the one location.

6. The user state determination device according to claim 1, wherein the predetermined state is a state in which the user needs to perform a non-purposeful visit to the one location.

7. The user state determination device according to claim 6, wherein the non-purposeful visit to the one location is a visit based on the user's loss or dropping of an article.

8. The user state determination device according to claim 2, further comprising an inquiry unit configured to inquire of a predetermined destination about whether the user is in the predetermined state when the determination unit determines whether the user is in the predetermined state,
wherein the inquiry unit determines whether the user is in the predetermined state on the basis of a response to the inquiry when the response is received.

9. The user state determination device according to claim 1, wherein the moving history information includes position information and time information.

10. A user state estimation device comprising:
an estimation unit configured to estimate that one user is in a predetermined state from the one user's behavior information at a specific location acquired by the user state determination device according to claim 1 using a predetermined state estimation model trained with information of the specific location and one or more users as an explanatory variable and with a predetermined state of each of the one or more users as an objective variable.
